(19) United States
(12) Patent Application Publication
(10) Pub. No.: US 2012/0021689 A1
(43) Pub. Date: Jan. 26, 2012

(54) SIGNALING METHOD AND DEVICE FOR MITIGATING INTERFERENCE IN M2M COMMUNICATION SYSTEM

(75) Inventor: Shuang Feng Han, Suwon-si (KR)

(73) Assignee: SAMSUNG ELECTRONICS CO., LTD., Suwon-si (KR)

(21) Appl. No.: 13/187,343

(22) Filed: Jul. 20, 2011

(30) Foreign Application Priority Data
Jul. 21, 2010 (KR) 10-2010-0070425

(51) Int. Cl. H04W 4/00; H04W 88/02; H04W 24/00

(52) U.S. Cl. 455/63.1

(57) ABSTRACT

A signaling method for mitigating interference by a device in a machine-to-machine (M2M) communication system. The device measures reference signals transmitted from other devices, and determines a Neighbor Device Set (NDS) including at least one device whose signal power is greater than or equal to a first threshold. Based on the measured values of the reference signals, the device sets up M2M communication with a first device, for data communication, and determines a Restricted Device List (RDL) including at least one device causing interference unallowable for communication with the first device based on the measured value of the reference signal from at least one device in the NDS. The device also transmits the RDL to at least one device in the NDS or the RDL, thereby mitigating the overall system interference.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Jul. 21, 2010 and assigned Serial No. 10-2010-0070425, the entire disclosure of which is hereby incorporated by reference.

### TECHNICAL FIELD OF THE INVENTION

The present invention relates to a signaling method and device for mitigating interference in a machine-to-machine communication system.

### BACKGROUND OF THE INVENTION

Machine-to-machine communication (M2M) is a new concept in communication that has originated from the telemetry technology that automatically measures and transmits data from remote sources by wire/wireless or other means.

This M2M communication literally means communication between one electronic device and another electronic device. In a broad sense, the M2M communication means wire/wireless communication between electronic devices, or communication between devices and machines controlled by people. Recently, however, it is general that the M2M communication refers especially to wireless communication between one electronic device and another electronic device, i.e., between machines.

M2M communication technology has been utilized for various purposes in conjunction with the existing mobile communication and wireless high-speed internet, or with low-power communication solutions such as WiFi and ZigBee. This technology is applied in automotive telematics, logistics management, intelligent metering systems, remote asset management systems, point-of-sale (POS) systems, and security-related fields.

As for the networks for M2M communication, the focus thereon has shifted from the static architecture such as a client-server model for connection to the internet, to the more dynamic and mobile networks. These networks are built based on many-to-many relationships formed from many distributed clients, meaning a change from the centralized structure such as Domain Name System (DNS) structure.

The M2M communication is realized by providing the server capability and the client capability to each of a number of communication nodes.

Recently, the development of mobile terminals equipped with wireless technology such as Bluetooth and IEEE 802.11 is noticeable. This development of mobile terminals makes M2M communication in mobile environments inevitable.

The M2M communication technology allows mobile phone users to make calls to one another directly without the intervention of the cell base station. In other words, the M2M communication technology may use mobile phones (e.g., cellular handsets) modified to act as peers or nodes in a specific network like a mesh network.

In M2M communication, there may be many devices talking to one another at the same time. M2M communication may be limited to arbitrary service coverage, and device relays may be required in an area out of the service coverage.

FIG. 1 illustrates multi-communication between devices in an M2M communication system.

Devices D1 to D8 shown in the drawing are in M2M communication. Among these devices, the device D3 104 receiving data from the device D1 100 may be subjected to interference due to the transmission signals from its neighbor devices (i.e., D2 102 and D5 106).

In other words, users may enjoy higher mobility and lower power consumption due to the M2M communication. However, devices in the M2M communication system may be subjected to significant interference caused by the coexistence of multiple communication links in the M2M communication system.

### SUMMARY OF THE INVENTION

To address the above-discussed deficiencies of the prior art, it is a primary object to provide a signaling method and device for mitigating interference in an M2M communication system.

Another aspect of the present invention is to provide a method and device for measuring information about reference signals transmitted by other devices, and suppressing data transmission by devices providing interference based on the measured information in an M2M communication system.

Another aspect of the present invention is to provide a configuration of a reference signal transmitted by a device in an M2M communication system.

In accordance with one aspect of the present invention, there is provided a signaling method for mitigating interference by a first device in a machine-to-machine (M2M) communication system. The signaling method includes measuring a signal power for each of a plurality of reference signals received from other devices, and determining a first list based on the signal power for each of the reference signals. The method also includes setting up M2M communication with a second device, for data communication. The method further includes measuring a signal power for each of reference signals received from devices included in the first list, and determining a second list based on the signal power for each of the reference signals received from the devices included in the first list. The method still further includes transmitting the second list to devices included in the first list or the second list.

In accordance with another aspect of the present invention, there is provided a signaling method for mitigating interference by a first device in a machine-to-machine (M2M) communication system. The signaling method includes receiving a second list from a second device. The method also includes determining whether the second list includes the first device. The method further includes waiting for data transmission until communication of the second device is terminated, if the second list includes the first device. The second list may include devices causing interference unallowable for data communication with the first device.

In accordance with another aspect of the present invention, there is provided a first device for performing interference mitigation signaling in a machine-to-machine (M2M) communication system. The first device includes a receiver configured to receive reference signals transmitted from other devices. The first device also includes a controller configured to measure a signal power for each of the reference signals, determine a first list based on the signal power for each of the reference signals, set up M2M communication with a second device for data communication, measure a signal power for each of a plurality of reference signals received from devices included in the first list, and determine a second list based on the signal power for each of the reference signals received from the devices included in the first list. The first device further includes a transmitter configured to transmit the second list to devices included in the first list or the second list.

In accordance with yet another aspect of the present invention, there is provided a first device for performing interference mitigation signaling in a machine-to-machine (M2M) communication system. The first device includes a receiver configured to receive a second list from a second device. The first device also includes a controller configured to determine whether the second list includes the first device, and wait for data transmission until communication of the second device is terminated, if the second list includes the first device. The second list may include devices causing interference unallowable for data communication with the first device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating multi-communication between devices in an M2M communication system;

FIG. 2 is a flow diagram illustrating a signaling procedure among devices in an M2M communication system according to an embodiment of the present invention;

FIG. 3 is a flowchart illustrating a method for mitigating interference by a device transmitting a restricted device list (RDL) in an M2M communication system according to an embodiment of the present invention;

FIG. 4 is a flowchart illustrating a method for mitigating interference by a device receiving an RDL in an M2M communication system according to an embodiment of the present invention; and

FIG. 5 is a schematic block diagram of a device for transmitting and receiving an RDL in an M2M communication system according to an embodiment of the present invention.

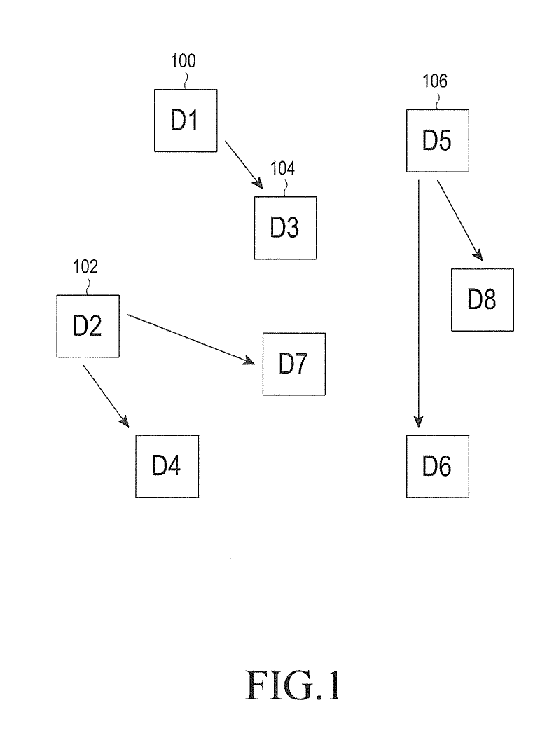

Throughout the drawings, the same drawing reference numerals will be understood to refer to the same elements, features and structures.

### DETAILED DESCRIPTION OF THE INVENTION

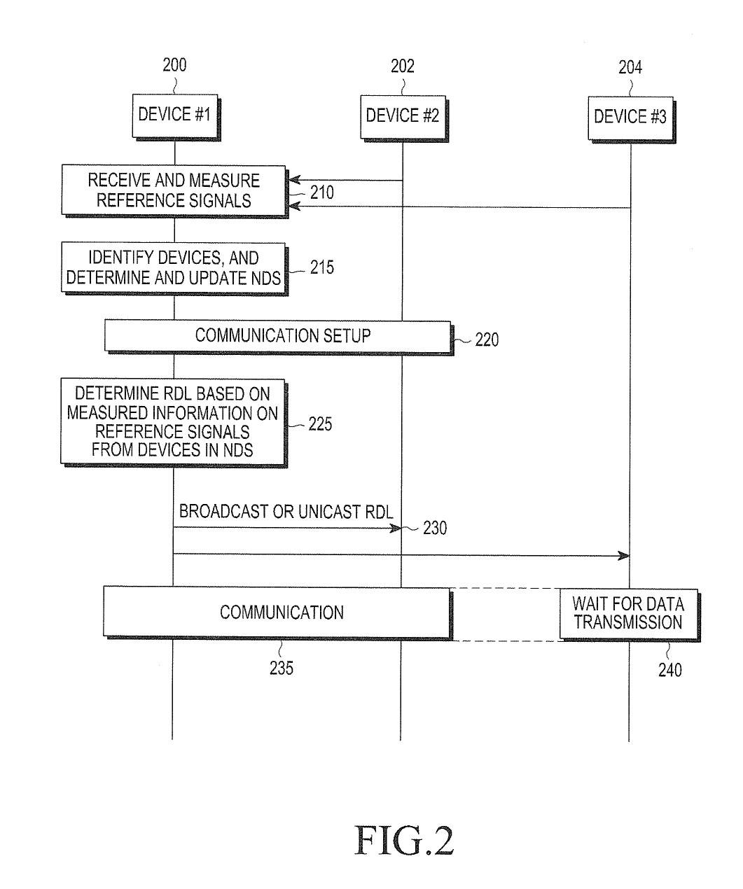

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system. Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The term ‘device’ as used herein may refer to any and every electronic device serving as a node and capable of communication in an M2M communication system.

FIG. 2 illustrates a signaling procedure among devices in an M2M communication system according to an embodiment of the present invention.

A device #1 200 receives unique reference signals from other devices 202 and 204, and measures information about the reference signals (block 210). The information about the reference signals may include, for example, a signal power and a Signal to Interference Noise Ratio (SINR). In some situations, the information about the reference signals may include not only an identification (ID) for device identification, but also an indicator indicating the state of a device, and an indicator indicating the transmission/reception progress of a device. A Neighbor Device Set (NDS) includes one or more IDs for device identification, and may optionally include device state information and transmission/reception progress information.

The device #1 200 identifies other adjacent devices 202 and 204 based on the information about the received reference signals, and determines and updates an NDS based on the reference signal information (block 215).

The device #1 200 determines an NDS based on the reference signal information, and may optionally include, in the NDS, IDs of the devices, signal powers of whose measured reference signals are greater than or equal to a predetermined threshold, determining those devices as devices located in the vicinity.

The reference signals from different devices are distinguished from each other. Optionally, the different devices may be distinguished, as they occupy time slots not overlapping those of other devices; as they use non-overlapping frequency resources; or as they use orthogonal sequences.

Optionally, the devices 202 and 204 may provide information indicating whether they are in transmission, reception, or idle state. Optionally, the three states may be distinguished by different formats of reference signals, may be distinguished by different time slots or different frequencies, or may be distinguished by indicators expressed with parts (e.g., two bits) of reference signals.

Optionally, a device in a transmission state informs its transmission progress periodically or occasionally. An indicator for indicating the progress may be delivered by a part (multiple bits, e.g., four bits or six bits) of a reference signal. For example, the indicator may indicate its associated transmission progress ratio in figures such as ¼, ⅓, ½, and ⅔.

Optionally, a device in a reception state informs its reception progress periodically or occasionally. An indicator for indicating the progress may be delivered by a part (multiple bits, e.g., four bits or six bits) of a reference signal. For example, the indicator may indicate its associated reception progress ratio in figures such as ¼, ⅓, ½, and ⅔.

Optionally, each device may inform its basic capability such as a supportable protocol, using a reference signal. Optionally, the basic capability may be included as a part of a device ID. An indicator for indicating the basic capability may be delivered by a part of a reference signal.

Therefore, in some situations, reference signals received from the devices 202 and 204 may include not only IDs for device identification, but also indicators indicating the states of the devices, and indicators indicating the transmission/reception progresses of the devices. The NDS includes IDs for device identification, and may optionally include state information and transmission/reception progress information of the devices.

The device #1 200 updates the NDS periodically or occasionally (block 215), in order to reflect in the NDS the reference signals indicating the state and progress information, which are transmitted from the devices 202 and 204 periodically or occasionally. This NDS is maintained for the purpose of the device #1 200 itself.

When the device #1 200 is ready to receive data from an arbitrary other device 202 by setting up M2M communication (block 220), the device #1 200 performs the following operation to mitigate interference.

Based on the information about reference signals from the devices included in the NDS, the device #1 200 calculates signal powers of the devices included in the NDS. Based on the calculated signal powers, the device #1 200 determines and maintains a Restricted Device List (RDL) including at least one device that causes interference unallowable for the communication set up to the other device 202 (block 225). In other words, the device #1 200 determines a list of devices that cause excessive interference among the devices included in the NDS, based on the information about the reference signals from the devices. To determine the RDL, the device #1 200 may use the reference signal information acquired in block 215, or may re-measure information about each of the reference signals received from the devices included in the NDS after the setup of the communication.

Optionally, the devices included in the RDL may be determined as devices having a received SINR greater than or equal to a threshold.

Before receiving data, the device #1 200 broadcasts the RDL, or transmits the RDL to the devices included in the RDL in a unicast way (block 230).

After transmitting the RDL, the device #1 200 receives data through M2M communication with the other device 202 (block 235).

Upon receiving the RDL transmitted in a broadcast or unicast communication, the device #3 204 included in the RDL does not perform its data transmission. In other words, the device #3 204 having received the RDL determines if the device #3 204 itself is included in the RDL, and if so, waits for its data transmission until the communication of the device #1 200 is terminated (block 240), thereby suppressing the transmission by a device(s) causing excessive interference and thus mitigating the overall system interference.

The device #3 204 waiting for its data transmission may determine the state and progress of the device #1 200 and determine a communication end time of the device #1 200, as it receives and measures reference signals and updates the NDS periodically or occasionally.

Specifically, if a state indicator included in the reference signal that the device #3 204 has received from the device #1 200 indicates an idle state, the device #3 204 may determine that the communication of the device #1 200 is terminated, and the device #3 204 may estimate a communication end time based on a progress indicator included in the reference signal. Upon detecting the communication termination of the device #1 200, the device #3 204 may resume its data transmission.

Although the method of mitigating interference from the device from which the master device desires to receive data has been described so far with reference to FIG. 2, the same method may be applied even to the device to which the master device desires to transmit data. In other words, the device #1 200 may achieve the interference mitigation effects by performing the RDL determination (block 225) and the RDL transmission (block 230) not only after the communication set up for data reception, but also after the communication set up for data transmission. However, because the interference mitigation is for improvement of reception performance, it is preferable to allow a receiving device to measure information about reference signals and determine an RDL based on the information, in providing more efficient interference mitigation effects.

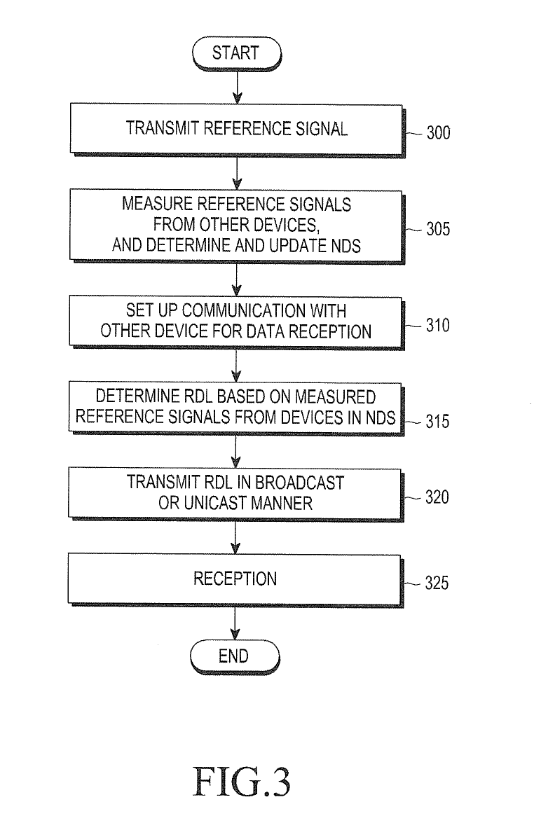

FIG. 3 illustrates a method for mitigating interference by a device #1 200 transmitting an RDL in an M2M communication system according to an embodiment of the present invention.

Referring to FIG. 3, the device #1 200 transmits a reference signal periodically or occasionally (block 300). The reference signal includes an ID for the device identification, and may optionally include an indicator indicating a state (transmission, reception, or idle state) of the device #1 200 and an indicator indicating the transmission/reception progress of the device #1 200.

The device #1 200 measures information about reference signals received from other devices 202 and 204, and determines an NDS, a set of its neighbor devices, by determining as neighbor devices the devices that have transmitted reference signals, signal powers of which are greater than a threshold. The device #1 200 updates the NDS periodically or occasionally (block 305).

If the device #1 200 sets up communication to receive data from other device (or device #2 202) (block 310), the device #1 200 determines an RDL, or a list of devices causing unallowable interference, based on the information about the reference signals received from the devices included in the NDS (block 315). Optionally, the devices included in the RDL may be determined as devices whose SINR is greater than a threshold. To determine the RDL, the device #1 200 may use the reference signal information acquired in block 305, or may re-measure information about the reference signals received from the devices included in the NDS after the setup of the communication in block 310.

Before receiving data, the device #1 200 broadcasts the RDL, or transmits the RDL to the devices included in the NDS or the RDL in a unicast way (block 320), and then receives data from the device #2 202 (block 325).

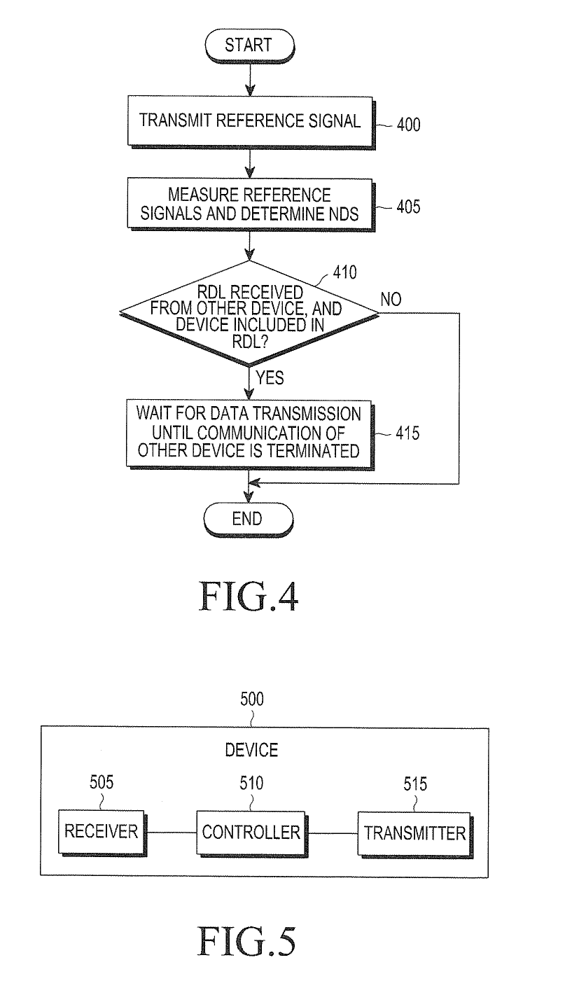

FIG. 4 illustrates a method for mitigating interference by a device #3 204 receiving an RDL in an M2M communication system according to an embodiment of the present invention.

Referring to FIG. 4, the device #3 204 transmits a reference signal periodically or occasionally (block 400). The reference signal includes an ID for device identification, and may optionally include an indicator indicating a state (transmission, reception, or idle state) of the device #3 204 and an indicator indicating the transmission/reception progress of the device #3 204.

The device #3 204 measures information about reference signals from other devices 200 and 202, and determines an NDS, a set of its neighbor devices, by determining as neighbor devices the devices whose signal powers are greater than a threshold. The device #3 204 updates the NDS periodically or occasionally (block 405).

Upon receiving an RDL from the other device #1 200, the device #3 204 determines if the device #3 204 itself is included in the RDL (block 410).

If it is determined in block 410 that the device #3 204 itself is included in the RDL, the device #3 204 waits for its data transmission until the communication of the other device #1 200 is terminated (block 415). The waiting for data transmission may include not only delaying the start of new transmission, but also interrupting the ongoing transmission. By doing so, it is possible to cancel interference caused by the device #3 204, thus mitigating the overall system interference.

The operations in FIGS. 2 to 4 may be achieved by a controller and a signal input/output unit included in a device according to an embodiment of the present invention. In other words, a device according to an embodiment of the present invention includes a transmitter for transmitting a reference signal, receiving reference signals from other devices, measuring information about the received reference signals, determining an NDS and an RDL based on the information about the reference signals, determining to transmit the RDL to other devices, receiving an RDL, determining to exchange data with other devices, and determining to wait for data transmission depending on whether the device belongs to the RDL, and a signal input/output unit for exchanging messages or signals with other devices under control of the controller.

A device for performing the operations in FIGS. 2 to 4 will now be described with reference to FIG. 5.

FIG. 5 schematically illustrates a structure of a device for transmitting and receiving an RDL in an M2M communication system according to an embodiment of the present invention.

Referring to FIG. 5, a device 500 includes a receiver 505, a controller 510, and a transmitter 515.

First, the device 500 receiving an RDL and performing an interference mitigation operation will be described.

The controller 510 controls the transmitter 515 to transmit a reference signal periodically or occasionally. The reference signal includes an ID for identifying the device 500, and may optionally include an indicator indicating a state (transmission, reception, or idle state) of the device 500 and an indicator indicating the transmission/reception progress of the device 500.

The controller 510 measures information about reference signals received from other devices, and determines an NDS or a set of its neighbor devices, by determining as neighbor devices the devices that have transmitted reference signals, signal powers of which are greater than a threshold. The controller 510 updates the NDS periodically or occasionally.

If the controller 510 sets up communication to receive data from other devices, the controller 510 determines an RDL or a list of devices causing unallowable interference, based on the information about the reference signals received from the devices included in the NDS. Optionally, the devices included in the RDL may be determined as devices whose SINR is greater than a threshold. To determine the RDL, the controller 510 may use the previously acquired reference signal information, or may re-measure information about each of the reference signals received from the devices included in the NDS after the setup of the communication.

Before receiving data, the controller 510 controls the transmitter 515 to broadcast the RDL, or to transmit the RDL to the devices included in the NDS or the RDL in a unicast way, and then receives data from other devices.

Next, the device 500 transmitting an RDL and performing an interference mitigation operation will be described. Herein, the same operations (i.e., an operation of transmitting a reference signal and an operation of determining an NDS) as those of the device 500 receiving an RDL and performing an interference mitigation operation will not be described.

Upon receiving an RDL from another device through the receiver 505, the controller 510 determines if the device 500 itself is included in the RDL. If so, the controller 510 controls the transmitter 515 to wait for data transmission until the communication of the other device is terminated. The waiting for data transmission may include not only delaying the start of new transmission, but also interrupting the ongoing transmission. By doing so, it is possible to cancel interference caused by the device 500, mitigating the overall system interference.

It should be noted that the message and operation flow diagrams illustrated in FIGS. 2 to 4 are not intended to limit the scope of the present invention. In other words, the operations in FIGS. 2 and 4 are mere examples of the operations performed in a device, and it is to be noted that not all of the processes are mandatory and they should not necessarily be performed individually by certain operations or algorithms.

The above-described operations may be achieved by installing a memory unit storing related program codes in a certain component of the device. In other words, each component of the device may read out the program codes stored in the memory unit and execute them by means of a processor or a Central Processing Unit (CPU), thereby performing the above-described operations.

As is apparent from the foregoing description, a device may measure reference signals transmitted from other devices, manage a set of devices which may cause interference to a neighbor device set, and suppress data transmission by this device set, thereby mitigating the overall system interference.

By applying a configuration of a reference signal transmitted by a device, the device may accurately detect the communication state of other device, precisely estimate a communication end time of the other device, and continuously update the state information.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A signaling method for mitigating interference by a first device in a machine-to-machine (M2M) communication system, the method comprising:
measuring a signal power for each of a plurality of reference signals received from other devices, and determining a first list based on the signal power for each of the reference signals;
setting up M2M communication with a second device, for data communication;
measuring a signal power for each of a plurality of reference signals received from devices included in the first list, and determining a second list based on the signal power for each of the reference signals received from the devices included in the first list; and
transmitting the second list to devices included in the first list or the second list.

2. The signaling method of claim 1, wherein the determining of the first list comprises:
comparing the signal power for each of the reference signals received from the other devices with a first threshold; and
creating the first list including other devices having transmitted reference signals whose signal powers are greater than or equal to the first threshold;
wherein the first list includes other devices located adjacent to the first device.

3. The signaling method of claim 2, wherein the determining of a second list comprises:
measuring a Signal to Interference Noise Ratio (SINR) for each of the reference signals received from the devices included in the first list;
comparing the measured SINRs with a second threshold; and
creating the second list including devices having transmitted reference signals whose SINRs are greater than or equal to the second threshold;
wherein the second list includes devices causing interference unallowable for the data communication.

4. The signaling method of claim 1, wherein the reference signal includes device identification information, and further includes at least one of a transmission/reception state indicator, a transmission/reception progress indicator, and a basic capability indicator.

5. The signaling method of claim 1, further comprising updating each of the first list and the second list periodically.

6. The signaling method of claim 1, wherein each of the reference signals received from the other devices occupies a time slot not overlapping those of reference signals from other devices, uses non-overlapping frequency resource, or uses an orthogonal sequence.

7. A signaling method for mitigating interference by a first device in a machine-to-machine (M2M) communication system, the method comprising:
receiving a second list from a second device;
determining whether the second list includes the first device; and
waiting for data transmission until communication of the second device is terminated, if the second list includes the first device;
wherein the second list includes devices causing interference unallowable for data communication with the first device.

8. The signaling method of claim 7, wherein the second list includes devices having transmitted reference signals whose Signal to Interference Noise Ratios (SINRs) are greater than or equal to a second threshold, from among devices included in a first list; and
wherein the first list includes other devices having transmitted reference signals whose signal powers are greater than or equal to a first threshold.

9. A first device for performing interference mitigation signaling in a machine-to-machine (M2M) communication system, the first device comprising:
a receiver configured to receive reference signals transmitted from other devices;
a controller configured to measure a signal power for each of the reference signals, determine a first list based on the signal power for each of the reference signals, set up M2M communication with a second device for data communication, measure a signal power for each of a plurality of reference signals received from devices included in the first list, and determine a second list based on the signal power for each of the reference signals received from the devices included in the first list; and
a transmitter configured to transmit the second list to devices included in the first list or the second list.

10. The first device of claim 9, wherein the controller compares the signal power for each of the reference signals received from the other devices with a first threshold, and creates the first list including other devices having transmitted reference signals whose signal powers are greater than or equal to the first threshold;
wherein the first list includes other devices located adjacent to the first device.

11. The first device of claim 9, wherein the controller measures a Signal to Interference Noise Ratio (SINR) for each of the reference signals received from the devices included in the first list, compares the measured SINRs with a second threshold, and creates the second list including devices having transmitted reference signals whose SINRs are greater than or equal to the second threshold;
wherein the second list includes devices causing interference unallowable for the data communication.

12. The first device of claim 9, wherein the reference signal includes device identification information, and further includes at least one of a transmission/reception state indicator, a transmission/reception progress indicator, and a basic capability indicator.

13. The first device of claim 9, wherein the controller updates each of the first list and the second list periodically.

14. The first device of claim 9, wherein each of the reference signals received from the other devices occupies a time slot not overlapping those of reference signals from other devices, uses non-overlapping frequency resource, or uses an orthogonal sequence.

15. A first device for performing interference mitigation signaling in a machine-to-machine (M2M) communication system, the first device comprising:
a receiver configured to receive a second list from a second device; and
a controller configured to determine whether the second list includes the first device, and wait for data transmission until communication of the second device is terminated, if the second list includes the first device;
wherein the second list includes devices causing interference unallowable for data communication with the first device.

16. The first device of claim 15, wherein the second list includes devices having transmitted reference signals whose Signal to Interference Noise Ratios (SINRs) are greater than or equal to a second threshold, from among devices included in a first list; and
wherein the first list includes other devices having transmitted reference signals whose signal powers are greater than or equal to a first threshold.

17. The signaling method of claim 1, wherein the first device and the second device are mobile phones.

18. The signaling method of claim 7, wherein the first device and the second device are mobile phones.

19. The first device of claim 9, wherein the first device and the second device are mobile phones.

20. The first device of claim 15, wherein the first device and the second device are mobile phones.
